(19) United States
(12) Patent Application Publication
(10) Pub. No.: US 2011/0226108 A1
(43) Pub. Date: Sep. 22, 2011

(54) CUTTING AND EXPANDING DEVICE

(75) Inventor: Bernd Cox, Weeze (DE)

(73) Assignee: KHS GmbH, Dortmund (DE)

(21) Appl. No.: 13/125,626

(22) PCT Filed: Jan. 20, 2010
(86) PCT No.: PCT/EP10/00314

§ 371 Date: Apr. 22, 2011

(30) Foreign Application Priority Data
Feb. 10, 2009 (DE) 10 2009 008 278.6
Feb. 13, 2009 (DE) 10 2009 008 936.5

(51) Int. Cl. B26D 7/06

(52) U.S. Cl. 83/436.3

(57) ABSTRACT

The invention relates to a cutting and expanding device for cutting a web of packaging material that is fed to the device via a web inlet into a plurality of individual webs that are conveyed away from the device at a web outlet and spaced apart from one another.

The invention relates to a cutting and expanding device according to the preamble of Claim 1.

The processing of web-shaped flat materials in the form of packaging films, in particular shrink films on packaging machines and in this case especially on shrink packagers is known. In this case products or packing means filled with products, such as, for example, bottles, cans, soft packaging, etc., but also sets made of up such products or packing means, are wrapped with the respective packaging film. In a shrink tunnel connected to the packaging machine, the film is shrunk-on in such a manner that said film is placed fixedly around the respective product or packing means, thereby obtaining a robust, saleable packet or set.

The webs of flat material used for the packaging, for example produced from packaging or shrink foil, are usually made available in a web width that is greater than the web width required for the further processing. Consequently it is a known fact that the original or required web of flat material is cut in a cutting and expanding device once or twice in the longitudinal direction of the web in order, in this manner, to create two or three individual webs that have the required web width for the packaging. In order to make it possible to process the individual webs, it is also necessary for said individual webs to be guided apart, i.e. expanded once they have been cut.

It is the object of the invention to provide a cutting and expanding device that, with a simplified structure, ensures a high level of flexibility with regard to the number of individual webs created by cutting. This object is achieved by a cutting and expanding device corresponding to Claim 1.

Further developments, advantages and application possibilities of the invention are produced from both the following description of exemplary embodiments and the Figures. In this case, all the features described and/or graphically represented, individually or in arbitrary combination, are in principle objects of the invention, irrespective of their summary in the claims or their dependency. The content of the claims is also made a component of the description.

The invention is explained below by way of the Figures of an exemplary embodiment, in which, in detail:

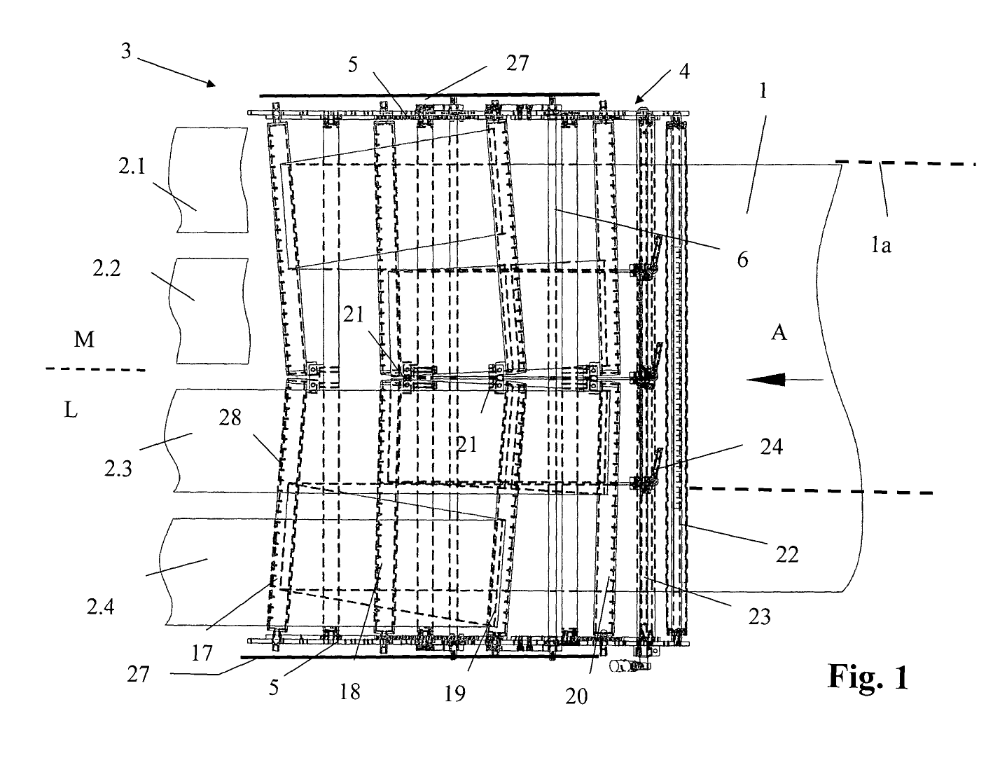

FIG. 1 shows a simplified representation and top view of a cutting and expanding device according to the invention;

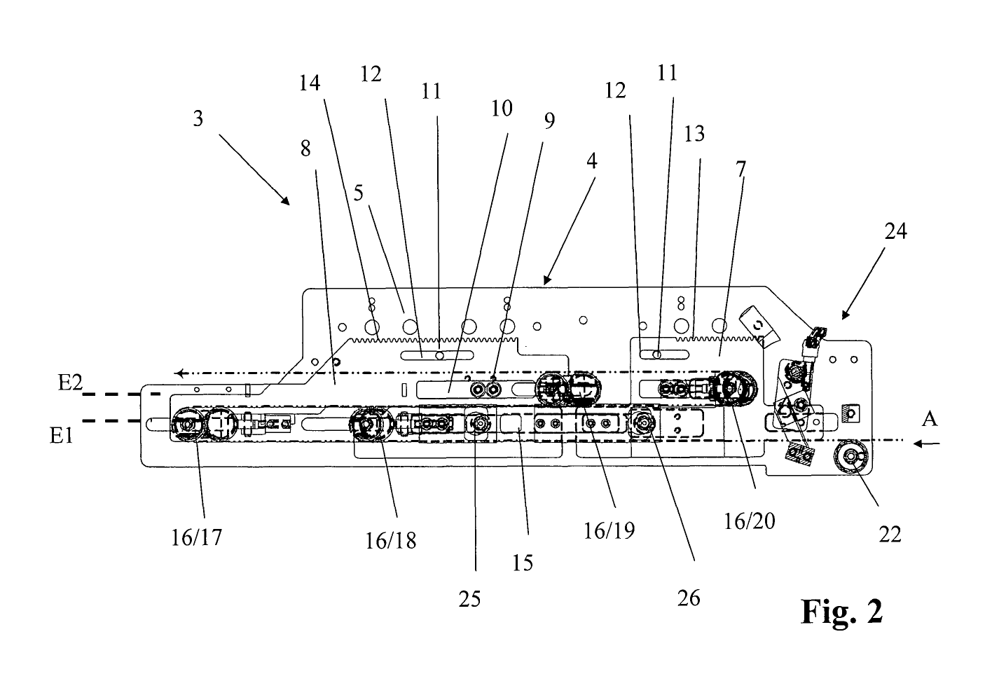

FIG. 2 shows a side view of the cutting and expanding device in FIG. 1.

In the Figures the reference 1 is given to a web of a flat material in the form of a packaging material or a packaging film, for example in the form of a shrink film, which is used to package products or packing means (not shown in any more detail) e.g. by means of a shrinking-on process in a packaging machine (not shown either).

For the packaging, the web 1, supplied in a conveying direction A, is cut in the longitudinal direction, and for example in a continuous manner, into a plurality of individual webs, i.e. in the representation in FIG. 1 into four individual webs 2.1-2.4, which, for example, have identical widths. This cutting is carried out in the cutting and expanding device given the general reference 3 in the Figures. In said device not only are the individual webs 2.1-2.4 created by cutting the web 1 supplied to a web inlet 3.1, but at the same time they are expanded, i.e. the individual webs 2.1q-2.4 are guided apart, in such a manner that the individual webs 2.1-2.4 moved away from the cutting and expanding device 3 at a web outlet 3.2 in the conveying direction A are spaced apart from each other.

The cutting and expanding device 3 is realized in a substantially mirror-symmetrical manner to a vertical centre plane M, which is oriented parallel to the conveying direction A of the web 1 and of the individual webs 2.1-2.4 and perpendicular to the plane of said webs, and includes, among other things, a device frame 4 with two flat or plate-like outer frame elements 5, which are arranged with their surface sides parallel to the conveying direction A and in planes perpendicular to the plane of the web 1. The frame elements 5 are spaced apart but are interconnected by crossheads 6 of the device frame 4. The distance between the frame elements 5 is greater than the width of the web 1 and also greater than the distance between the outer longitudinal sides of the two outer individual webs 2.1 and 2.4. The device frame 4 is oriented with its frame longitudinal axis L in the conveying direction A.

Two adjusting plates 7 and 8 are provided offset from each other in the direction of the frame longitudinal axis L in each case on the outside of each frame element 5 remote from the interior of the device frame 4, said adjusting plates abutting against the inside surface of the associated frame element 5 and being provided on said frame element 5 so as to be displaceable by a predetermined travel in the direction of the frame longitudinal axis L by means of guide means, as indicated by way of the double arrow H7 for the adjusting plates 7 or by way of the double arrow H8 for the adjusting plates 8 in FIG. 2.

The guide means that make the adjusting of the adjusting plates 7 and 8 possible are, for example, guide rollers 9 that are rotatably mounted on the frame element 5 and are accommodated in slotted-hole-like guide openings 10 in the adjusting plates 7 and 8, and guide pins 11 that engage in associated slotted slots 12 in the adjusting plates 7 and 8 and that at the same time also define the maximum possible travel H7 or H8 of the adjusting plates.

The adjusting plates 7 and 8 are provided in each case with teeth 13 on the upper side. The adjusting plate 7 on one side of the device frame 4 is connected in a driving manner to the adjusting plate 7 on the other side of the device frame 4 via the teeth 13, and this is by means of a transmission arrangement (not represented) that interacts with the teeth 13 and has a shaft (not represented either) that extends between the frame elements 5 and is rotatably mounted in said frame elements. The adjusting plates 8 on both sides of the device frame 4 via their teeth 14 and a transmission arrangement including a shaft are connected together in a driving manner in the same way. The adjusting of the adjusting plates 7 and 8 is effected in a manual and/or motor-driven manner via the transmission arrangement, preferably one single transmission arrangement being provided for all the adjusting plates 7 and 8.

A coupling plate 15 is secured to each adjusting plate 7, said coupling plate extending away from the adjusting plate 7, overlapping the adjusting plate 8 in a part region and at its end remote from the adjusting plate in the region of an opening in the adjusting plate 8 having a bearing 16. Corresponding bearings 16 are also provided on the adjusting plates 7 and 8.

A plurality of rollers 17-20 are mounted so as to be freely rotatably in the device frame 4, these being, proceeding from the web outlet 3.2 in opposition to the conveying direction A on each side of the centre plane M, a first roller 17, connecting thereto a second roller 18, connecting thereto a third roller 19 and connecting thereto a fourth roller 20. The rollers 19-20 are therefore provided in duplicate. In the case of the embodiment represented, all the rollers 17-20 with a circular-cylindrical-shaped lateral surface have the same outside diameter.

In the embodiment represented, the rollers 17 and 18 are arranged with their axes in a common plane E1 parallel or substantially parallel to the plane of the web 1 at the web inlet 3.1 and the axes of the rollers 19 and 20 are arranged in a common plane E2, which is also parallel or substantially parallel to the plane of the web 1 at the web inlet 3.1, however extending at a spacing above the plane E1, the spacing between the planes E1 and E2 being at least equal the diameter of the rollers 17-20.

The rollers 17 and 19 are in each case mounted so as to be freely rotatable by way of an outer end in a bearing 16 in one of the adjusting plates 8 and by way of an inner end in the region of the centre plane M in a central bearing 21.

The two rollers 18 are mounted so as to be freely rotatable by way of their outer ends in each case in a bearing 16 in a coupling plate 15 and at their inner ends in the region of the centre plane M in a bearing 21. The two rollers 20 are rotatably mounted at their outer ends in a bearing 16 at the adjusting plate 7 and at their inner ends adjacent the centre plane M in bearings 21. The bearings 21 are, for example, provided in each case on one of the crossheads 6 or on an inner frame element that is connected to the crossheads 6.

A further roller 22, extending over the entire width of the device frame 4, is mounted at the web inlet 3.2 between the frame elements 5 so as to be freely rotatable and is used to support the web 1. A plurality of cutting devices 24 are provided at the web inlet 3.1 at a crosshead 23 following the roller 22 in the conveying direction A, said cutting devices, in the embodiment represented, being formed in each case by a cutting knife and by way of which cutting knives the web 1 being cut into the individual webs 21.-2.4. The cutting devices 24 are adjustable along the crosshead 23, i.e. parallel to the plane of the web 1 and perpendicular to the conveying direction A. In addition, the cutting devices 24 are in each case moveable individually between a cutting state in which the relevant cutting device 24 effects the cutting of the web 1, and a non-operational state, for example by means of pivoting.

As can be seen in particular in FIG. 1, the rollers 17-20 are set inclinedly, in such a manner that the axes of said rollers are, it is true to say, in each case in planes parallel or substantially parallel to the plane of the web 1 at the web inlet 3.1, however with the centre plane M they enclose an angle that is less than 90° that opens towards the web outlet 3.2. As can also be seen in FIG. 1, the arrangement is additionally such that the rollers 17 and 19 and the rollers 18 and 20 in each case form a roller group on each side of the centre plane M, and such that the rollers of each roller group are arranged with their axes parallel or substantially parallel to each other.

In order to cut the web 1 into the four individual webs 2.1-2.4, three cutting devices 24 are provided, for example in such a manner that the distance between the two outer cutting devices 24 and the respective edge of the web 1 and the mutual distance between two cutting devices 24 is equal to the width of the individual webs 2.1-2.4.

The two outer individual webs 2.1 and 2.4 are created with the two outer cutting devices 2.4. These individual webs extend initially within the cutting and expanding device 3 in each case to one of the rollers 17, then around said roller upward to one of the rollers 19 and around said roller upward again such that the relevant individual web 2.1 or 2.4 leaves the cutting and expanding device above the plane E2.

The central individual webs 2.2 and 2.3 are created by the outer cutting devices 24 and by the central cutting device 24 and extend within the cutting and expanding device 3 initially to one of the rollers 18, then around this roller upward to one of the rollers 20 and around this roller upward such that the relevant individual web 2.2 and 2.3 then leaves the cutting and expanding device 3 in the conveying direction A once again above the plane E2.

Through the inclined position of the rollers 17-20, the expanding of the individual webs 2.1-2.4 is achieved in such a manner that said individual webs at the web outlet 3.2 are parallel to each other with their longitudinal extension and are spaced apart from each other. The distance between the individual webs 2.1-2.4 is adjustable through the inclined position of the rollers 17-20.

As shown in FIG. 1, the inclined position of the rollers 18 and 20 is less than the inclined position of the rollers 17 and 19, i.e. the angle enclosed by the axes of the rollers 18 and 20 and the centre plane M is greater than the corresponding angle between the axes of the rollers 17 and 19. The inclined position of the rollers 17-20 and consequently the spacing between the individual webs 2.1-2.4 are adjustable by displacing the adjusting plates 7 and 8. The bearings 16 and 21 are realized such that they enable the adjustment or the change in the inclined position of the rollers 17-20.

The cutting and expanding device 3 offers not only the possibility of separating the supplied web 1 by cutting it into four individual webs 2.1-2.4 and, for example, of adjusting the distance between the individual webs 2.1-2.4 by changing the inclined position of the rollers 17-20, but it is also possible with the cutting and expanding device 3 to separate a supplied web 1 into only two individual webs, then purely the central cutting device 24 being used and the two individual webs created by cutting being guided, for example, via the rollers 18 and 20.

It is also possible to separate a web into three individual webs. Usually in this case the central knife is removed or taken out of engagement. The rollers 18 and 20 are set for guiding the central web such that they are aligned in an identical manner, that is to say they have a common axis of rotation. In addition, it is possible for the relevant web to be supplied to the web inlet 3.1 in a manner that is not symmetrical with reference to the centre plane M deviating from FIG. 1, but to be supplied to the web inlet 3.1 in a manner that is asymmetrical, as is indicated in FIG. 1 by the broken lines for the web 1a. Using two cutting devices 24 the web 1a is separated into the individual webs 2.1-2.3, of which the individual web 2.1 is guided around the rollers 17 and 19 and the two individual webs 2.2 and 2.3 are guided in each case via the rollers 18 and 20.

Obviously, the cutting and expanding device 3 can also be used such that the supplied web 1 is supplied via the web outlet 3.2 to a further use uncut, i.e. in the form of one single web. In this case, at least the rollers that interact with the web, for example the rollers 18 and 20, are then set such that they are oriented with their axes in each case perpendicular to the centre plane M.

The references 25 and 26 refer to adjusting devices that are realized, for example, as eccentrics and by way of which the bearings 21 of the rollers 17-20, at least however a minimum of one bearing 21 of each roller group 17/19 and 18/20, are adjustable in the longitudinal direction of the frame L, this being the bearings 21 of the rollers 18 and/or 20 via the adjusting device 25 and the bearings 21 of the rollers 17 and/or 19 via the adjusting device 26?. In order to achieve this, the adjusting of the crossheads 6 or frame elements on which the bearings 21 are provided is effected in each case via the adjusting device 25 or 26.

The reference 27 is given in FIG. 1 to lines that are connected to a source for a pressurized gaseous fluid, for example to a compressed air source. The lines 27 j are connected via rotary connecters to roller channels realized in the rollers 17-20, said roller channels, in their turn, communicating with a plurality of outlet or nozzle openings 28 on the circumferential or lateral surface of the rollers 17-20. During the operation of the cutting and expanding device 3, the webs 2.1-2.4 are blown-on from inside by the fluid emerging from the nozzle openings 28 (compressed air), thereby reducing the friction between the respective web and the rollers interacting with said web and the tension on the cut individual webs 2.1-2.4.

The essential characteristics and advantages of the cutting and expanding device can be summarized as follows:
The cutting and expanding device 3 makes it possible for two, three or four webs to be created by cutting from one supplied web 1 and also for the supplied web 1 to be supplied uncut to a further use.
Through the adjusting device that is formed by the adjusting plates 7 and 8 and the adjusting elements 25 and 26, it is not only possible to adjust the angle of the rollers 17-20 with reference to the centre plane M, but also to adjust said rollers in the longitudinal direction L of the device frame 4 and consequently to adjust the respective web length inside the cutting and expanding device 3. In particular, in this way it is possible to make an adjustment in such a manner that the length of the individual webs 2.1-2.4 situated in the cutting and expanding device 3 in each case is precisely identical, which is of great importance in particular when processing webs 1 in the form of printed packaging films or shrink films.
A further advantage of the cutting and expanding device 3 is in its compact design and in the fact that in particular through the free accessibility of the rollers 17-20, it is also possible to introduce the respective web-shaped flat material with a relatively small amount of effort, the same also being true of changing between cutting the supplied web 1 into two webs, three webs and four webs.
Irrespective of the number of webs created by cutting, the flat material is guided in each case only via a few rollers or directional axes. This produces not only a sturdy design but also less tension on the individual webs 2.1-2.4 guided away from the cutting and expanding device 3 at the web outlet 3.2.
A further essential advantage is that the individual webs 2.1-2.4 lie in a common plane even at the web outlet 3.2, thereby simplifying the production of subsequent devices for processing the individual webs.
The driving connection at least between the adjusting plates 7 associated with each other and the adjusting plates 8 associated with each other achieves a same-directional parallel adjustment of the rollers 18 and 20 or 17 and 19, with the advantage of simplified adjustability of the cutting and expanding device 3.

The invention has been described above by way of an exemplary embodiment. It is obvious that numerous changes and conversions are possible without in any way departing from the inventive concept underlying the invention.

### LIST OF REFERENCES

1 Web made of flat material

2.1-2.4 Individual webs created by cutting

3 Cutting and expanding device

3.1 Web inlet

3.2 Web outlet

4 Device frame

5 Frame element

6 Crosshead

7, 8 Adjusting plate

9 Guide roller

10 Slotted hole

11 Guide pin

12 Slotted hole

13, 14 Teeth

15 Coupling plate

16 Bearing

17-20 Roller

21 Bearing

22 Support roller

23 Crosshead

24 Cutting device

25, 26 Adjusting device

27 Line

28 Nozzle opening on lateral surface of the roller 17-20

A Feed direction of the web 1 or of individual webs 2.1-2.4

L Device longitudinal axis

M Vertical centre plane

1. An apparatus for cutting a web of a packaging material supplied to a web inlet into a plurality of individual webs that are conveyed away at a web outlet and that are spaced apart from one another, said apparatus comprising a cutting and expanding device including:
a plurality of rollers that rotate in a direction following in a device longitudinal axis at the web inlet or at a cutting station at the web inlet, the rollers forming roller groups, each of which includes at least two rollers,
adjusting means are provided for adjusting an inclined position of the rollers or of their axes with reference to a reference plane common to all the rollers.

2. The apparatus of claim 1, wherein the number of roller groups is equal to a maximum number of individual webs that can be created by cutting.

3. The apparatus of claim 1, wherein the rollers are provided at a cutting station at the web inlet, said cutting station being formed by a plurality of cutting tools or cutting elements.

4. The apparatus of claim 1, wherein at least one roller of each roller group, or a bearing thereof is adjustable in the direction of the device longitudinal axis, in the web running direction, or in the conveying direction.

5. The apparatus of claim 1, wherein the reference plane is a plane perpendicular to a plane of the supplied web and/or perpendicular to a plane of one of the plurality of individual webs conveyed away at the web outlet.

6. The apparatus of claim 1, wherein the rollers are oriented in a mirror-symmetrical manner relative to a centre plane.

7. The apparatus of claim 1, wherein the rollers of a roller group are adjustable together.

8. The apparatus of claim 1, wherein the rollers are adjustable between a position in which they are oriented with their axes perpendicular to the reference plane and positions in which the axes of the rollers enclose with the reference plane an angle less than 90° that opens towards the web outlet.

9. The apparatus of claim 1, wherein the rollers are
mounted by way of an outside roller end on an outer bearing in a region of an outer frame element and
mounted by way of their inner ends on an inner bearing,
the apparatus further comprising adjusting means by way of which at least the position of the outer bearing can be changed to change the inclined position of the bearings.

10. The apparatus of claim 1,
wherein the rollers are mounted by way of an outer roller end and an outer bearing in a region of an outer frame element and by way of their inner ends on an inner bearing,
said apparatus further comprising at least one adjusting device for adjusting a position of at least one inner bearing.

11. The apparatus of claim 1, wherein each roller group consists of two rollers.

12. The apparatus of claim 1, wherein the rollers define four roller groups.

13. The apparatus of claim 1, further comprising means for exposing a surface side of the web material to a gaseous fluid in the region of the rollers, the surface side facing the roller.

14. The apparatus of claim 1, further comprising a packaging station on which is installed the cutting and expanding device of claim 1.

15. The apparatus of claim 1, wherein the reference plane is a vertical reference plane.

16. The apparatus of claim 6, wherein the center plane is the reference plane.

17. The apparatus of claim 7, wherein the rollers of each roller group in each position of the adjustment are arranged in parallel relative to each other.

18. The apparatus of claim 12, wherein the four roller groups comprise two roller groups on a first side of a center plane and two roller groups on a second side of the center plane.
